(19) United States
(12) Patent Application Publication
(10) Pub. No.: US 2023/0084720 A1
(43) Pub. Date: Mar. 16, 2023

(54) Process for manufacturing and bonding a shoe rubber outsole

(71) Applicant: Henkel AG & Co., KGaA, Duesseldorf (DE)

(72) Inventors: Se Hee Roh, Busan (KR); Myoungchul Ryu, Busan (KR); Young Tae Cho, Lippo Karawaci (ID)

(21) Appl. No.: 18/056,860

(22) Filed: Nov. 18, 2022

Related U.S. Application Data
(63) Continuation of application No. PCT/EP2021/052739, filed on Feb. 5, 2021.

(30) Foreign Application Priority Data
Jun. 2, 2020 (EP) 20177864.4

(51) Int. Cl. A43B 13/32; A43D 25/20; A43B 13/04; C09J 175/06

(52) U.S. Cl. CPC A43B 13/32; A43D 25/20; A43B 13/04; C09J 175/06

(57) ABSTRACT

The present invention relates to a process for manufacturing a shoe rubber outsole using a special heat and pressure stable water-based polyurethane dispersion adhesive without a pre-treatment of UV irradiation or plasma, as well as a process for manufacturing a shoe using the outsole manufactured as described herein and an PUD-based adhesive composition for the described processes.

The present invention relates to a process for manufacturing a shoe rubber outsole using a special heat and pressure stable water-based polyurethane dispersion adhesive without a pre-treatment of UV irradiation or plasma, as well as a process for manufacturing a shoe using the outsole manufactured as described herein and an polyurethane dispersion-based adhesive composition for the described processes.

Generally, a rubber outsole is prepared by vulcanizing unvulcanized rubber which is cut into a planar or structured shape. Examples of conventional technologies related to this rubber outsole preparation method are disclosed in Korean Patent Registration No. 10-0191275 and Korean Patent Application Publication No. 2000-0063527 as well as in international patent publication WO 2011/020757 A2.

Korean Patent Registration No. 10-0191275 discloses a method of integrally forming a rubber outsole of a shoe and a polyurethane midsole, including the steps of: forming a rubber outsole such that a band-shaped projecting part having a predetermined width is provided over the entire periphery thereof and reticularly-arranged protrusions are formed on the surface thereof; heat-treating the rubber outsole such that the surface temperature thereof is about 40 to 50° C.; and spraying an undiluted polyurethane solution onto the heat-treated rubber outsole to integrally form a midsole on the rubber outsole.

Korean Patent Application Publication No. 2000-0063527 discloses a shoe outsole and a method of manufacturing the same in which the outsole and midsole are simultaneously formed and attached through a single process.

International patent publication WO 2011/020757 A2 discloses methods of manufacturing shoes by using a multifunctional primer. In the described processes, the unvulcanized rubber outsole is coated with a multifunctional primer comprising a polyurethane dispersion (PUD), a butadiene rubber solution and a natural rubber solution before vulcanization. The outsole is then thermally activated, coated with an adhesive and attached to the other shoe parts.

International patent publication WO 2017103063 A1 discloses a process for manufacturing a shoe rubber outsole, comprising the steps of: (1) treating an uncured rubber material by UV irradiation or plasma; (2) applying an adhesive composition to the treated rubber material of the step (1) and drying the rubber material, wherein said adhesive composition comprises a heat and pressure stable water-based polyurethane dispersion; (3) curing the rubber material obtained in the step (2).

While the above-described methods are already advantageous over the conventional processes in that they provide for processes that avoid laborious additional washing steps, there is still need in the art for simplification of a rubber outsole and/or shoe manufacturing process.

Accordingly, an object of the present invention is to provide a further simplified method of manufacturing a shoe.

In order to accomplish the above object, a first aspect of the present invention provides a process for manufacturing a shoe rubber outsole, comprising the steps of:
a. providing an uncured rubber material;
b. applying an adhesive composition to the uncured rubber material of the step (1) and drying the uncured rubber material, wherein said adhesive composition comprises a heat and pressure stable water-based polyurethane dispersion; and
c. curing the rubber material obtained in the step (2), wherein the adhesive composition comprises relative to the total weight of the composition:
d. 85 to 99.9 wt. % of a water-based polyurethane dispersion, preferably a polyester polyol based polyurethane;
e. 0.1 to 1 wt. % of at least one cross-linker, preferably a polycarbodiimide;
f. 0.1 to 10 wt. % of at least one modified polyolefin based adhesion promoter, preferably comprising a modified polyolefin, a (meth)acrylate, and an emulsifier;
g. 0 to 5 wt. % of at least one filler, preferably fumed silica;
h. 0 to 0.1 wt. % of at least one fluorescent agent; and
i. 0 to 1 wt. % of at least one HEUR thickener.

In another aspect, the invention is directed to a process for manufacturing a shoe, comprising:
1) thermally activating the shoe rubber outsole obtained according to the process for manufacture of a shoe rubber outsole as described herein; and
2) attaching the activated shoe rubber outsole to one or more other shoe parts, preferably a shoe midsole.

In still another aspect, the present invention is also directed to an adhesive composition for an uncured rubber material, comprising relative to the total weight of the composition:
85 to 99.9 wt. % of a water-based polyurethane dispersion, preferably a polyester polyol based polyurethane;
0.1 to 1 wt. % of at least one cross-linker, preferably a polycarbodiimide;
0.1 to 10 wt. % of at least one modified polyolefin based adhesion promoter, preferably comprising a modified polyolefin, a (meth)acrylate, and an emulsifier;
0 to 5 wt. % of at least one filler, preferably fumed silica;
0 to 0.1 wt. % of at least one fluorescent agent; and
0 to 1 wt. % of at least one HEUR thickener.

The use of said adhesive composition for treatment of an uncured rubber material, preferably a shoe rubber outsole, is also encompassed by the present invention.

It has surprisingly been found that by using such a process as described herein several washing steps necessary in the conventional processes known, for example, from KR 10-0191275 and KR 2000-0063527, as well as separate priming and cementing steps can be omitted. In addition, the special treatment by UV irradiation or plasma as disclosed in WO 2017103063 A1 can also be removed. The application of the special heat and pressure-stable PUD obviate the need for these additional steps and thus significantly simplifies and accelerates the manufacturing process. More specifically, existing processes include a first step of heat-pressing the uncured rubber outsole to cure the rubber material, followed by a step of degreasing the rubber outsole, drying, priming, another drying step, thermally activating the rubber outsole material, application of the adhesive, drying and attaching the other shoe parts. The improved process described in WO 2011/020757 A2 still requires the use of a multifunctional primer composition that is coated onto the uncured rubber material of the outsole without a prior degreasing step prior to curing. After curing, the material is thermally activated and then the adhesive is applied to facilitate attachment of the other shoe parts. The further improved process described in WO 2017103063 A1 still requires the UV irradiation or plasma to pretreat the rubber material. In contrast to these methods, the present process includes the step of providing the uncured material, replacing the priming step, then directly applying the adhesive composition without UV irradiation or plasma treatment. After curing, the rubber outsole material is thermally activated at a temperature of at least 55° C. and then the other shoe parts are attached.

“Heat and pressure stable”, as used herein in relation to the PUD adhesive, refers to a PUD that can withstand the heat and pressure typically applied for rubber cure, i.e. vulcanization. This usually means a temperature of about 150 to 200° C., typically about 160° C., and a pressure of 50 to 200 bar (kgf/cm²), typically about 150 bar, for about 5 to 10 minutes. This means that said PUD does not suffer from substantial polymer degradation under said conditions.

It has been found that the adhesive composition according to the present invention can achieve an excellent bonding strength when directly cured/crosslinked on the rubber surface in rubber vulcanization process without a pre-treatment of UV irradiation or plasma. This has the advantage that no additional primer that is used to ensure compatibility and adhesion between the rubber material and the adhesive is needed.

The rubber material may be any rubber material known and used for shoe production. Accordingly, included are natural as well as synthetic rubber materials, such as butadiene-based rubbers, including, inter alia, butadiene rubber, acrylonitrile-butadiene rubber, styrene-butadiene-styrene rubber and the like. The rubber material that is provided in step (1) of the process described herein may already be preformed, for example by cutting or any other forming technology, to the planar or structured shape of a shoe outsole. The final form of the outsole is typically obtained during the curing, which is commonly done by heat-pressing.

In the next step the uncured and untreated rubber material is contacted with the adhesive composition comprising a PUD, typically by spraying/brushing/painting the composition onto the rubber material surface. Alternatively, other well-known coating and application techniques can be used. The PUD is a water-based polyurethane polymer dispersion, preferably comprising 30 or more, typically 40 to 60% by weight solids (as, for example, determined by drying loss measurements at 150° C. for 30 minutes to evaporate the water/solvents), with the solids being mainly composed of the polyurethane polymer particles of a diameter between 30 and 1000 nm, preferably between 100 and 500 nm, more preferably between 150 and 300 nm (as determined by dynamic light scattering (DLS) according to ISO 22412).

The liquid phase of the dispersion comprises or consists of water, and may, in certain embodiments, also include minor amounts of organic solvents or other liquid components, although it is preferred that it consists essentially of water, i.e. to about 95 vol. %. In the PUD, the liquid phase makes up 40 to 70% by weight, typically 40 to 60% by weight.

The polyurethane polymer particles can be made of any suitable polyurethane, typically thermoplastic polyurethanes, preferably made of polyester or polyester polyols and a molar excess, relative to the molar ratio of isocyanate and hydroxyl groups, of polyisocyanates. The polyols are preferably linear polyols. In various embodiments, the polyurethane is thus an NCO-terminated polyurethane, preferably obtained from a reaction mixture comprising a polyester polyol, preferably obtained from a reaction mixture comprising adipic acid and 1,4-butanediol, and a molar excess relative to the molar ratio of isocyanate and hydroxyl groups of a polyisocyanate, preferably an aliphatic diisocyanate, more preferably hexamethylenediisocyanate (HDI) or isophoronediisocyanate (IPDI).

In various embodiments, the adhesive composition comprises, in addition to the PUD, which comprises polyurethane polymer particles and water, one or more additional components, such as, for example, known auxiliaries, including fillers, stabilizers, conservatives, antifoaming agents, emulsifiers, rheology modifying agents, colorants, and the like.

The adhesive compositions of the present invention preferably contain at least one cross-linker, with the cross-linker preferably being selected from polycarbodiimides and polyaziridines, more preferably polycarbodiimides. Exemplary cross-linkers that can be used according to the invention include, without limitation, N,N′-dicyclohexylcarbodiimide (DCC) and N,N′-diisopropylcarbodiimide (DIC). The cross-linker is advantageous, as it renders the polyurethane heat and pressure stable and less prone to degradation, as discussed above. Commercially available PUD-based adhesives without such a cross-linker often lack the required heat and pressure stability necessary to withstand the rubber vulcanization conditions.

The modified polyolefin based adhesion promoter improves the compatibility between rubber and PUD in the adhesive and modifies the rubber surface to generate the initial cohesion grow-up.

As the main component in the adhesion promoter, modified polyolefins generally include modified polyolefins obtained by unsaturated carboxylic acid or acid anhydride modification, acryl modification, chlorinating modification or combinations of such modifications of polyolefins. As the modified polyolefins having a polyoxyalkylene chain, there may be used a polyoxyethylene chain, polyoxypropylene chain or a polyoxyethylene and polyoxypropylene block chain.

The adhesion promoter optionally comprises one or more (meth)acrylates to improve the compatibility with the rubber and bonded adhesive layer, and in turn to increase the bonding performance of the adhesive composition. As examples of the (meth)acrylates, there may be mentioned alkyl esters of (meth)acrylic acid such as methyl (meth)acrylate, ethyl (meth)acrylate, n- or i-propyl (meth)acrylate, n-, i- or t-butyl (meth)acrylate, 2-ethylhexyl (meth)acrylate, cyclohexyl (meth)acrylate, lauryl (meth)acrylate, stearyl (meth)acrylate and the like, and any of these may be used alone or in combinations of two or more. Throughout the present specification, the term “(meth)acrylic” means “acrylic or methacrylic”, and the term “(meth)acrylate” means “acrylate or methacrylate”.

The modified polyolefins may be added in the adhesive composition as aqueous dispersion which is obtained by dispersing the modified polyolefin in an aqueous medium, and optionally adding an emulsifier.

As examples of emulsifiers there may be mentioned nonionic emulsifiers such as polyoxyethylene monooleyl ether, polyoxyethylene monostearyl ether, polyoxyethylene monolauryl ether, polyoxyethylene tridecyl ether, polyoxyethylene phenyl ether, polyoxyethylene nonylphenyl ether, polyoxyethylene octylphenyl ether, polyoxyethylene monolaurate, polyoxyethylene monostearate, polyoxyethylene monooleate, sorbitan monolaurate, sorbitan monostearate, sorbitan trioleate and polyoxyethylene sorbitan monolaurate; and anionic emulsifiers such as sodium salts or ammonium salts of alkylsulfonic acid, alkylbenzenesulfonic acid and alkylphosphoric acid; as well as polyoxyalkylene group-containing anionic emulsifiers having an anionic group and a polyoxyalkylene group such as a polyoxyethylene group or polyoxypropylene group in the molecule or reactive anionic emulsifiers having an anionic group and a polymerizable unsaturated group in the molecule, any of which may be used alone or in combinations of two or more.

In various embodiments, the adhesive composition comprises relative to the total weight of the composition:
85 to 99.9 wt. %, preferably 90 to 99 wt. % of a water-based polyurethane dispersion;
0.1 to 1 wt. %, preferably 0.1 to 0.5 wt. % of at least one cross-linker;
0.1 to 20 wt. %, preferably 0.05 to 10 wt.-% of at least one modified polyolefin based adhesion promoter;
0 to 5 wt. %, preferably 0.2 to 3 wt. % of at least one filler;
0 to 0.1 wt. %, preferably 0.01 to 0.05 wt. % of at least one fluorescent agent; and
0 to 1 wt. %, preferably 0.3 to 0.8 wt. % of at least one HEUR thickener.

In one preferred embodiment, the modified polyolefin based adhesion promoter comprises a modified polyolefin, a (meth)acrylate, and an emulsifier. The filler used in the adhesive composition may be selected from all known fillers suitable for PUD-based adhesives and the disclosed rubber applications. Preferred fillers are fumed silicas.

Another preferred group of additives used in the adhesion composition are optical brighteners. Use may be made here of the optical brighteners which are customary in adhesives. They are added as an aqueous solution or solution in an organic solvent to the polymer solution. Examples of optical brighteners are derivatives of diaminostilbenedisulfonic acid or its alkali metal salts. Suitable, for example; are salts of 4,4′-bis(2-anilino-4-morpholino-1,3,5-triazinyl-6-amino)stilbene-2,2′-disulfonic acid or compounds of similar structure which instead of the morpholino group carry a diethanolamino group, a methylamino group, an anilino group or a 2-methoxyethylamino group. Furthermore, brighteners of the substituted diphenylstyryl type may be present in the adhesive composition; and examples being the alkali metal salts of 4,4′-bis(2-sulfostyryl)biphenyl, 4,4′-bis(4-chloro-3-sulfostyryl)biphenyl or 4-(4-chlorostyryl)-4′-(2-sulfostyryl)biphenyl, Mixtures of the aforementioned brighteners may also be used.

HEUR type thickeners (hydrophobically modified ethylene oxide-urethane block copolymers) are also known in the art and all thickeners of these type suitable for the disclosed applications can be used.

The adhesive composition is preferably liquid and has a viscosity of less than 5,000 mPa·s, preferably from 10 to 2,000 mPa·s, more preferably 50 to 1,000 mPa·s at 25° C. as determined by a Brookfield viscometer (Spindle No. 63, 12 rpm). This allows simple application of the composition onto the uncured rubber material by existing instrumentation without unnecessary dripping, etc.

The step of curing the rubber material treated with the adhesive composition is preferably carried out by heat-pressing. This heat-pressing leads to vulcanization of the rubber and is typically carried out at temperatures above 120° C., such as 150 to 200° C., preferably about 160° C., and under increased pressure, such as 50 bar or more, typically 50 to 200 bar, preferably about 150 bar. The heat-pressing is carried out for a time sufficient to allow full curing of the rubber material, typically 2 minutes or more, such as 3 to 30 minutes, commonly 5 to 10 minutes. For the heat-pressing known and existing instrumentation may be used. In fact, the step of heat-pressing is carried out under the same conditions and using the same instrumentation as currently known in the art. As also mentioned above, the curing step may also include the feature of giving the rubber material the final form of the outsole. Typically, the rubber material is provided in form of a preform, which may, for example, be roughly cut to the form of the outsole. In these embodiments, the curing process, in particular by heat-pressing, imparts the final form to the outsole. The heat-pressing (vulcanization) may thus be carried out in a mold.

The manufacture of the shoe rubber outsole preferably comprises no additional washing steps or steps of applying a primer or an adhesive other than that described above. However, after application of the adhesive, a drying step can be carried out.

Once the shoe outsole has been manufactured, said rubber outsole may be used for the manufacture of the complete shoe. In such a process, the outsole is typically attached to other shoe parts, in particular the midsole. This process is generally carried out by thermally activating the shoe rubber outsole and then attaching the other shoe parts, in particular the shoe midsole, to the outsole. Other shoe parts that may be attached to the outsole or the midsole in this process include, without limitation, an insole, an upper and the like.

The step of thermally activating the rubber outsole material is generally known in the art and preferably includes heating the material to a temperature of more than 50 or 55° C. or higher. Preferred are temperatures in the range of 55 to 65° C. The step preferably takes 30 to 200 seconds, more preferably about 100 seconds. Thereafter, the activated rubber outsole is attached to another shoe part, preferably the midsole, and optionally the upper part of the shoe, typically by using a hydraulic (walled) sole attaching machine.

As already described in connection with the process of manufacturing the shoe outsole, the process of manufacturing the shoe does preferably neither includes any additional steps of degreasing or cleaning the outsole prior to the thermal activation and attachment nor steps of priming or applying another adhesive to the shoe rubber outsole prior to the activation and attachment step. However, it is possible to subject the other shoe parts, in particular the midsole, to conventional treatments before attachment to the outsole.

As described above, the method of manufacturing a shoe according to the present invention, compared to conventional shoe manufacturing methods, is advantageous in that steps of washing and priming a rubber outsole need not be conducted, thus improving productivity. Further, the method of manufacturing a shoe according to the present invention is advantageous in that production costs can be reduced by decreasing the number of workers and facilities due to the omission of the washing and priming processes and in that a shoe can be manufactured in an manner friendly to the environment due to the omission of the washing process.

The present invention also covers the special adhesive composition used in the processes of the invention and the use thereof for treatment of an uncured rubber material, preferably a shoe rubber outsole. It is understood that all the embodiments disclosed above in connection with the inventive processes, in particular those relating to the composition of the adhesive, are similarly applicable to the adhesive composition as such and its use.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The following examples further serve to illustrate the invention without, however, limiting it thereto.

### EXAMPLES

### Example 1: Adhesive Composition

| | | parts |
|---|---|---|
| | | by |
| No. | Material | weight |
| 1 | Polyester PUD | 93.0 |
| | (based on NCO-terminated polyurethane prepolymer | |
| | prepared from adipic acid/1,4-butanediol and | |
| | HDI(base)/IPDI) | |
| | solid content: 48-50% | |
| | particle size: 200-240 nm (determined by DLS) | |
| 2 | Modified polyolefin (about 10% aqueous solution | 5.0 |
| | containing (meth)acrylate and emulsifier, commercially | |
| | available from Soo Technical Corporation, South Korea | |
| | under the trade name of ST-NIC-2000) | |
| 3 | N,N′-dicyclohexylcarbodiimide or N,N′- | 0.2 |
| | diisopropylcarbodiimide (in 2-methoxy-1-methylethyl | |
| | acetate) | |
| 4 | Fumed silica | 1.0 |
| | (15% solution in water) | |
| 5 | Optical brightener (Tinopal ® NFW 10 liquid, | 0.02 |
| | commercially available from BASF) | |
| 6 | HEUR type thickener | 0.5 |

### Manufacture:

1. Input material no. 1 into tank and start mixing for 30 minutes.
2. Mix material no. 2 and no. 3 in sequence and mix
for 1 hr at room temperature.
3. Input material no. 4 slowly and mixing for 1 hour.
4. Input material no. 5 slowly and mixing for 1 hour.
5. Input material no. 6 by dropping around
for 1 hour and mixing for 3 hours.

### Example 2: Shoe Manufacture

The adhesive composition according to example 1 was uniformly applied to an unvulcanized rubber outsole using a sprayer and then a rubber vulcanization process was performed at 160° C. and 150 bar for 420 seconds. The vulcanized rubber outsole was thermally activated in a heating chamber at 55° C. for about 100 seconds. Thereafter, the thermally activated rubber outsole was manually attached to a midsole and an upper and then further attached using a hydraulic walled sole attaching machine to manufacture a shoe.

After 1 day and/or 18 days, tests for measuring the bonding strength between the rubber outsole and the midsole were conducted by measuring peel strength using a peel tester (5580, Instron).

The bonding strength of a shoe manufactured according to the present invention was 7.5 and 8.1 kgf/cm² after 1 day and 18 days respectively and the rubber materials were broken. It was also observed for a shoe that had been manufactured using the same process but Dispercoll U 2793 XP (PUD-based adhesive, commercially available from Bayer MaterialScience), that the bonding strength showed only 4.0 and 4.3 kgf/cm² after 1 day and 18 days respectively and the adhesives were separated from the rubber material.

For comparative purposes, the average bonding strength of a shoe manufactured according to a conventional manufacturing process using UV radiation pre-treatment as described in Example 1 of WO 2017103063 A1, and of a shoe manufactured according to the process steps of the present invention but using an adhesive composition having no adhesive promoter were also determined as 5.0 kgf/cm², and 3.5 kgf/cm² with point failure, respectively, which were significantly lower than that achieved according to the process of the present invention.

1. A process for manufacturing a shoe rubber outsole, comprising the steps of:
1) providing an uncured rubber material;
2) applying an adhesive composition to the uncured rubber material of the step (1) and drying the rubber material, wherein said adhesive composition comprises a heat and pressure stable water-based polyurethane dispersion; and
3) curing the rubber material obtained in the step (2),
wherein the adhesive composition comprises, based on the total weight of the composition:
a) 85 to 99.9 wt. % of a water-based polyurethane dispersion;
b) 0.1 to 1 wt. % of at least one cross-linker;
c) 0.1 to 10 wt. % of at least one modified polyolefin based adhesion promoter;
d) 0 to 5 wt. % of at least one filler;
e) 0 to 0.1 wt. % of at least one optical brightener; and
f) 0 to 1 wt. % of at least one hydrophobically modified ethylene oxide-urethane block copolymer (HEUR) thickener.

2. The process according to claim 1, wherein
(i) the uncured rubber material in step (1) is a shoe rubber outsole preform; and
(ii) the rubber material obtained in step (2) is cured and formed to a shoe rubber outsole in step (3); and
(iii) the curing in step (3) is by heat-pressing.

3. The process according to claim 1, wherein the process does not comprise an additional step of treating the uncured rubber material by UV irradiation or plasma.

4. The process according to claim 1, wherein the water-based polyurethane dispersion is an NCO-terminated polyurethane obtained from a reaction mixture comprising a polyester polyol and a polyisocyanate
wherein the polyester polyol is prepared with adipic acid and 1,4-butanediol,
wherein the polyisocyanate is selected from hexamethylenediisocyanate (HDI) or isophoronediisocyanate (IPDI), and
wherein the reaction mixture has a molar excess of the hydroxyl group than the isocyanate.

5. The process according to claim 1, wherein the cross-linker is selected from the group consisting of polycarbodiimides and polyaziridines.

6. The process according to claim 1, wherein the modified polyolefin based adhesion promoter comprises modifying polyolefins with unsaturated carboxylic acid modification, acid anhydride modification, acryl modification, chlorinating modification or combinations thereof.

7. The process according to claim 1, wherein the filler is fumed silica.

8. The process according to claim 1, wherein the adhesive composition is liquid and has a viscosity of less than 5,000 mPa·s at 25° C. as determined by a Brookfield viscometer (Spindle No. 63, 12 rpm).

9. A process for manufacturing a shoe, comprising
(1) manufacturing the shoe rubber outsole according to claim 1;
(2) thermally activating the shoe rubber outsole of step 1; and
(3) attaching the activated shoe rubber outsole of step 2 to shoe.

10. The process according to claim 9, wherein the process does not comprise additional steps of degreasing, cleaning, priming or applying adhesive to the shoe rubber outsole prior to the step (3).

11. An adhesive composition for an uncured rubber material, comprising based on the total weight of the composition:
a) 85 to 99.9 wt. % of a water-based polyurethane dispersion;
b) 0.1 to 1 wt. % of at least one cross-linker;
c) 0.1 to 10 wt. % of at least one modified polyolefin based adhesion promoter comprising a modified polyolefin, a (meth)acrylate, and an emulsifier;
d) 0 to 5 wt. % of at least one filler;
e) 0 to 0.1 wt. % of at least one optical brightener; and
f) 0 to 1 wt. % of at least one hydrophobically modified ethylene oxide-urethane block copolymer (HEUR) thickener.

12. An article comprising a substrate and the adhesive composition according to claim 11.

13. The article of claim 12, wherein the substrate is an uncured rubber material.

14. The article of claim 12, wherein the uncured rubber material is selected from the group consisting butadiene rubber, acrylonitrile-butadiene rubber or styrene-butadiene-styrene rubber.

15. The article of claim 12 is a shoe rubber outsole.
